(19) United States
(12) Patent Application Publication
(10) Pub. No.: US 2023/0253825 A1
(43) Pub. Date: Aug. 10, 2023

(54) MOBILE DEVICE CASE POWER DETECTION CIRCUITRY

(71) Applicant: TARGUS INTERNATIONAL LLC, Anaheim, CA (US)

(72) Inventors: Man Cheung Dan Tsang, Carlsbad, CA (US); Kam Shing Lee, Hong Kong (CN); Ronald DeCamp, Bonney Lake, WA (US)

(21) Appl. No.: 17/650,465

(22) Filed: Feb. 9, 2022

(51) Int. Cl. H02J 50/10; H02J 7/00

(52) U.S. Cl. CPC H02J 50/10; H02J 7/00032; H02J 7/0042

(57) ABSTRACT

Detecting power at a detachable case of a mobile device may include identifying a first electrical connection at the detachable case. The first electrical connection may include the detachable case receiving power from a wireless charging device. The detachable case may provide the received power from the wireless charging device to the mobile device. A second electrical connection may be identified at the detachable case. The second electrical connection may include the detachable case receiving at least one of power or data from a wired device coupled to the detachable case for transmission to the mobile device. When the second electrical connection includes receiving power from the wired device, the received power from the wired device may be provided to the mobile device while refraining from providing the power from the wireless charging device to the mobile device.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example environment of a portable electronic device (PED) case having power detection circuitry in accordance with one embodiment.

FIGS. 2A-2C illustrate different views of one embodiment of the PED case.

FIG. 3 illustrates a flowchart of a method for detecting power at a detachable case of a mobile device in accordance with one embodiment.

FIG. 4 illustrates an example computer architecture that facilitates operation of the principles described herein.

### DETAILED DESCRIPTION

Portable electronic devices (PEDs), including smartphones, notebook computers, tablet computers, and portable digital assistants have become a mainstream part of modern life. Generally, such PEDs include batteries from which they draw power in order to operate. This enables the portability of the PED by allowing a user to power (and therefore use) the PED in many diverse locations without being constrained only to locations that have an external power source immediately available for use with the PED. In order to enjoy this benefit, the battery of a PED must first be charged so that the PED has a power source to draw from during the time that it is being used away from an external power source.

Arranging for the battery of a PED to be properly charged can cause a user to expend valuable time and effort. For example, a user may be notified by the PED that the PED of a battery is almost discharged. This can occur in cases where the PED has been used between charges long enough to discharge the battery. In order to continue to use the PED, the user may thus be required to attach an appropriate charger for the battery of the PED to the PED. Because of the portable nature of the PED, this need may arise when the user is far away from the usual equipment with which the user typically charges the PED, meaning that the user must expend effort and/or other resources (e.g., money) to obtain another appropriate charger. Some PED chargers located during this search may not be of the correct type for the user’s device. Even when an appropriate PED charger is located, it may be stationary, requiring the PED to remain in one location while it charges (thus removing the benefits of portability associated with the PED during that time).

Advancements in battery charging technology now allow for a properly equipped PED to charge wirelessly. One such standard is the QI® (Qi) standard, which uses inductive coupling principles to charge the battery of a properly equipped PED with a properly equipped wireless charger. By using induction, a wireless charger (e.g., a Qi wireless charger) may charge a PED configured to use a standard corresponding to the wireless charger (e.g., the Qi standard) without the need for a physical link between the wireless charger and the PED. In order to charge the PED, a Qi charger (or other wireless charger) may need to be in close enough proximity to the PED and in the proper position relative to the PED for the induction principle to operate between the devices. Other wireless charging methods and protocols (other than the methods and protocols used by Qi) are possible, and are contemplated as being within the scope of this disclosure.

Despite these advancements, many PEDs still do not include such wireless charging technology. For instance, tablets often fail to include wireless charging technology. As a result, in such instances an external receiver has to be used in order to charge a PED (i.e., a PED that doesn’t have a built-in receiver coil). To ameliorate the lack of built-in wireless receiving coils, a case having an embedded receiver coil can provide power from wireless charging via an input port of a PED. However, the PED may then not be able to communicate with a host or other devices as the PEDs only input port is being occupied during charging. Accordingly, embodiments herein discuss the use of PED (or mobile device) cases that include both an embedded coil(s) for wireless charging and power detection circuitry that can still allow for providing data communications (e.g., wired data communications) to the PED during the provision of power via wireless charging at the case.

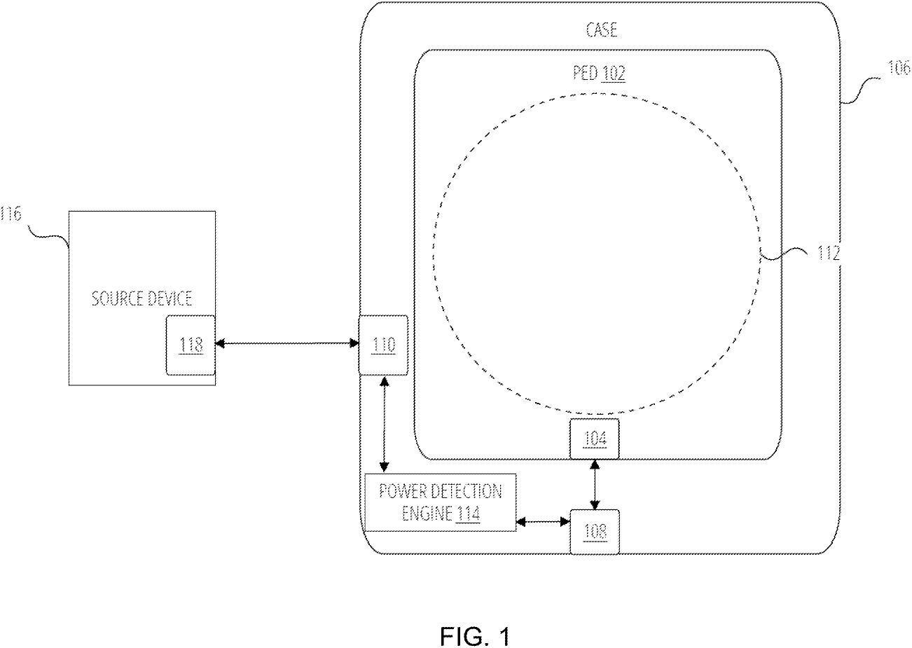

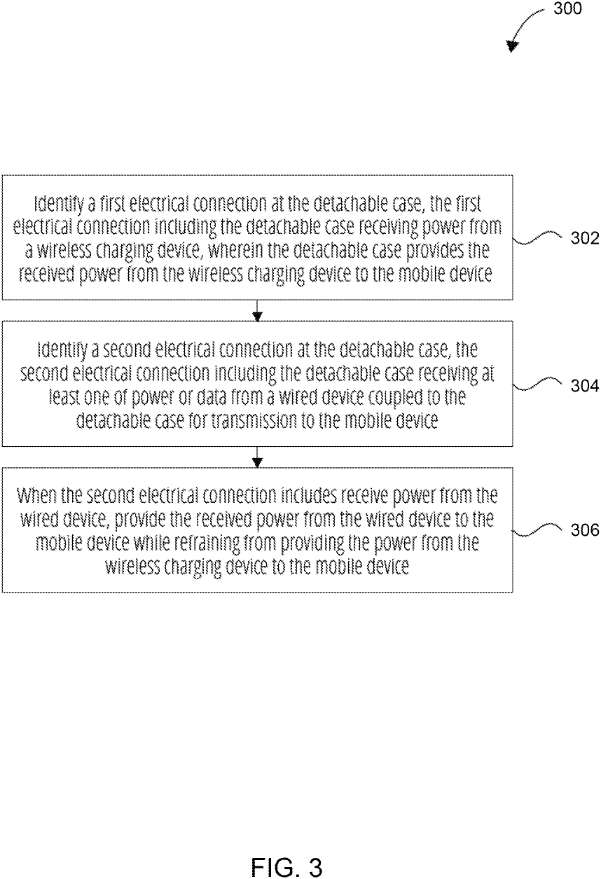

FIG. 1 illustrates an example environment of a PED case having power detection circuitry. As shown, FIG. 1 includes a PED 102, a PED case 106, and a source device 116. In an example, the PED 102 may comprise a tablet (e.g., Apple® iPad™, SamsungⓇ Galaxy™, Amazon® Kindle™, etc.) having a single female connector 104. The PED 102 may be embodied, for example, by computing system 300, as described with respect to FIG. 3. In addition, the female connector 104 may utilize any applicable standard for electrically receiving power and/or data. In an example, the female connector 104 may utilize Universal Serial Bus Type-C (USB Type-C). In another example, the female connector may utilize micro-USB.

Additionally, any of a wide variety of materials and manufacturing methods may be used to produce the various components of the presently described case for PEDs. For example, the PED case 106 and components of the PED case included in the various embodiments described herein may utilize various plastics, rubbers, nylons, glasses, fabrics, leathers, and/or other suitable materials.

As shown, the PED case 106 includes a male connector 108, a female connector 110, a receiver coil 112, and a power detection engine 114. The PED case 106 may be shaped or otherwise configured to mechanically couple to and secure at least portions of the PED 102. For instance, the PED case 106 may connect to the PED 102 magnetically (e.g., via magnets embedded within the PED case 106).

The male connector 108 of the PED case 106 may allow the PED case 106 to also electrically connect to the PED 102. In particular, the receiver coil 112 (i.e., shown as a circle with a dotted-line) may be configured to interact with a wireless charging device to thereby charge a battery of the PED 102 via an electrical connection between the male connector 108 of the PED case 106 and the female connector 104 of the PED 102. Again, the male connector 108 may utilize any particular standard for electrically connecting to the female connector 104 (e.g., USB Type-C).

The female connector 110 may be configured to electrically connect with an external device (e.g., the source device 116 via male connector 118) that is configured to provide data and/or power to the PED 102 via the PED case 106. In an example, the source device 116 may comprise a USB drive configured to store data that is accessible when connected to a computing system (e.g., the PED 102), an external power supply configured to charge a battery of a computing system (e.g., the PED 102), and so forth.

Accordingly, in some instances, the PED 102 may be provided power by both the receiver coil 112 via coupling with a wireless charger and an external power supply connected to the PED case 106 (i.e., via the male connector 118 of the source device 116 and the female connector 110 of the PED case 106). In such instances, the power detection engine 114 may be configured to determine that the source device 116 is currently providing power for charging the PED 102. In response to such determination, the PED case 106 may stop providing power via the receiver coil 112 (in conjunction with a wireless charger) to the PED 102. In contrast, when the source device 116 is providing only data (i.e., no power), the power detection engine 114 may allow power generated via wireless charging by the receiver coil 112 to be provided to the PED 102 along with the data provided by the source device 116. Accordingly, the power detection engine 114 may allow for the concurrent provision of power from the receiver coil 112 and data from an external source (e.g., the source device 116) to the PED 102 via the PED case 106 while also restricting concurrent provision of power from the receiver coil 112 and an external source to only the external source.

Notably, the power detection engine 114 may comprise any combination of hardware and/or software configured to determine when power is being received via both the receiver coil 112 and an external source (e.g., the source device 116) electrically connected to the female connector 110 of the PED case 106. Accordingly, the power detection engine 114 (and/or the PED case 106) may also be embodied, for example, by at least portions of the computing system 300.

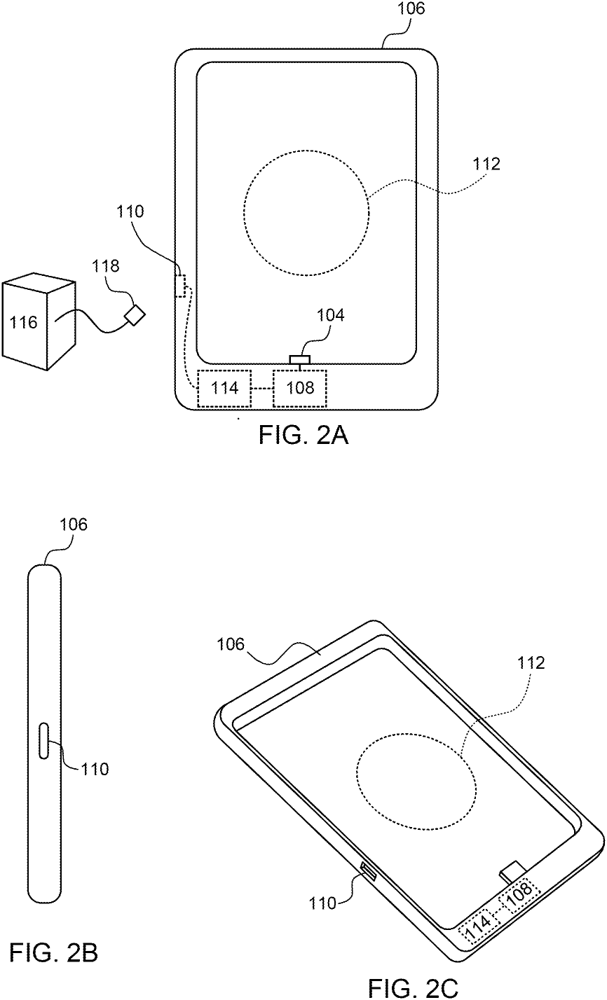

FIGS. 2A, 2B, and 2C illustrate a plan view, side view, and perspective view, respectively, of one embodmient of the PED case 106. Numbered elements correspond to those described in FIG. 1 above.

FIG. 3 illustrates a flowchart of a method 300 for detecting power at a detachable case of a mobile device. In block 302, the method 300 identifies a first electrical connection at the detachable case. For instance, a first electrical connection at the PED case 106 of FIG. 1 may be identified. The first electrical connection may include the detachable case receiving power from a wireless charging device. For instance, the receiver coil 112 of the PED case 106 may be electrically coupled to a wireless charging device to thereby generate power for charging a battery of (or simply powering) a mobile device. The detachable case may provide the received power from the wireless charging device to the mobile device. For example, the power generated by the receiver coil 112 and the wireless charging device may be provided to the PED 102 to charge a battery of the PED 102 or to power the PED 102.

In block 304, the method 300 identifies a second electrical connection at the detachable case. For instance, a second electrical connection may be identified at the PED case 106 of FIG. 1. The second electrical connection may include the detachable case receiving at least one of power or data from a wired device coupled to the detachable case for transmission to the mobile device. For example, the second electrical connection may be embodied by the connection of the source device 116 to the PED case 106.

In block 306, the method 300, when the second electrical connection includes receives power from the wired device, provides the received power from the wired device to the mobile device while refraining from providing the power from the wireless charging device to the mobile device. For instance, the wired device (e.g., the source device 116) may comprise an external power supply configured to charge a battery of the PED 102 and connected to PED 102 via the PED case 106 (e.g., an input port of the PED case 106 being electrically connected to the source device 116 and an output port of the PED case 106 being electrically connected to the PED 102). In such instances, the power detection engine 114 of the PED case 106 may facilitate provision of the power generated by the source device 116 to the PED 102 while simultaneously stopping the provision of power from the receiver coil 112/a wireless charging device to the PED 102.

The method 300 may further include the detachable case including at least one coil configured to provide power to the mobile device when the detachable case is electrically coupled to the wireless charging device. The method 300 may further include identifying that the at least one of power or data from the wired device includes only data, and based on identifying, continuing to provide the received power from the wireless charging device to the mobile device and providing the data received from the wired device to the mobile device.

The method 300 may further include identifying that the at least one of power or data from the wired device includes power and data, and based on identifying, providing the received power from the wired device to the mobile device while refraining from providing the power from the wireless charging device and providing the data received from the wired device to the mobile device.

The method 300 may further include the wired device comprising an external power supply. The method 300 may further include the wired device comprising a Universal Serial Bus (USB) storage device. The method 300 may further include the second electrical connection using a Universal Serial Bus (USB) Type-C connection.

In this way, the principles described herein allow for providing wireless charging for mobile devices (or PEDs) that lack embedded wireless charging systems while still allowing for the provision of data from devices external to the mobile device (and the case through which wireless charging may be provided). In addition, the principles described herein provide for both the provision of power and data from devices external to the mobile device while still providing the option of wireless charging via a removable case having an embedded wireless charging receiver coil (e.g., receiver coil 112).

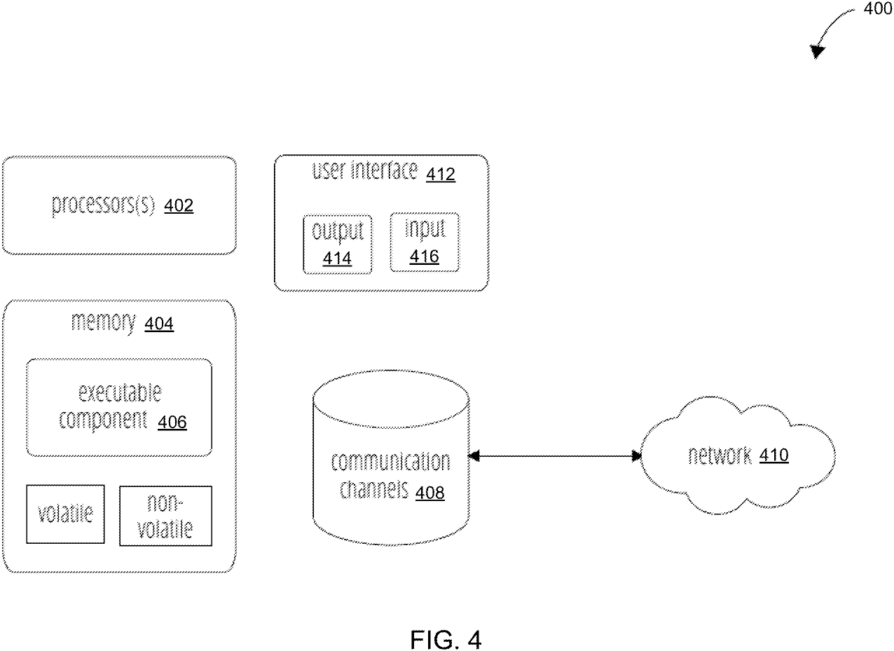

Some general discussion of a computing system will now be described with respect to FIG. 4. Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses, smart watches, and so forth). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 4, in its most basic configuration, a computing system 400 typically includes at least one hardware processing unit 102 (or processors(s) 402 and memory 404. The memory 404 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 400 also has thereon multiple structures often referred to as an “executable component.” For instance, the memory 404 of the computing system 400 is illustrated as including executable component 406. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component is binary). Alternatively, the structure may be configured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “control”, or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 404 of the computing system 400. Computing system 400 may also contain communication channels 408 that allow the computing system 400 to communicate with other computing systems over, for example, network 410.

While not all computing systems require a user interface, in some embodiments, the computing system 400 includes a user interface 412 for use in interfacing with a user. The user interface 412 may include output 414 (or output mechanism(s) 114) as well as input 416 (or input mechanism(s) 116). The principles described herein are not limited to the precise type of output 414 or type of input 416 as such will depend on the nature of the device. However, output 414 might include, for instance, speakers, displays, tactile output, holograms and so forth. Examples of input 416 might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” (e.g., the network 410) is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for detecting power at a detachable case of a mobile device, the method comprising:
identifying a first electrical connection at the detachable case, the first electrical connection including the detachable case receiving power from a wireless charging device, wherein the detachable case provides the received power from the wireless charging device to the mobile device;
identifying a second electrical connection at the detachable case, the second electrical connection including the detachable case receiving at least one of power or data from a wired device coupled to the detachable case for transmission to the mobile device; and
when the second electrical connection includes receiving power from the wired device, providing the received power from the wired device to the mobile device while refraining from providing the power from the wireless charging device to the mobile device.

2. The method of claim 1, wherein the detachable case includes at least one coil configured to provide power to the mobile device when the detachable case is electrically coupled to the wireless charging device.

3. The method of claim 1, further comprising:
identifying that the at least one of power or data from the wired device includes only data; and
based on identifying, performing the following:
continuing to provide the received power from the wireless charging device to the mobile device; and
providing the data received from the wired device to the mobile device.

4. The method of claim 1, further comprising:
identifying that the at least one of power or data from the wired device includes power and data; and
based on identifying, performing the following:
providing the received power from the wired device to the mobile device while refraining from providing the power from the wireless charging device; and
providing the data received from the wired device to the mobile device.

5. The method of claim 1, wherein the wired device comprises an external power supply.

6. The method of claim 1, wherein the wired device comprises a Universal Serial Bus (USB) storage device.

7. The method of claim 1, wherein the second electrical connection uses a Universal Serial Bus (USB) Type-C connection.

8. A computing system comprising:
a processor; and
a memory storing instructions that, when executed by the processor, configure the computing system to:
identify a first electrical connection at the detachable case, the first electrical connection including the detachable case receiving power from a wireless charging device, wherein the detachable case provides the received power from the wireless charging device to the mobile device;
identify a second electrical connection at the detachable case, the second electrical connection including the detachable case receiving at least one of power or data from a wired device coupled to the detachable case for transmission to the mobile device; and
when the second electrical connection includes receive power from the wired device, provide the received power from the wired device to the mobile device while refraining from providing the power from the wireless charging device to the mobile device.

9. The computing system of claim 8, wherein the detachable case includes at least one coil configured to provide power to the mobile device when the detachable case is electrically coupled to the wireless charging device.

10. The computing system of claim 8, wherein the memory stores further instructions that, when executed by the processor, configure computing system to:
identify that the at least one of power or data from the wired device includes only data; and
based on identifying, perform the following:
continue to provide the received power from the wireless charging device to the mobile device; and
provide the data received from the wired device to the mobile device.

11. The computing system of claim 8, wherein the memory stores further instructions that, when executed by the processor, configure computing system to:
identify that the at least one of power or data from the wired device includes power and data; and
based on identifying, perform the following:
provide the received power from the wired device to the mobile device while refraining from providing the power from the wireless charging device; and
provide the data received from the wired device to the mobile device.

12. The computing system of claim 8, wherein the wired device comprises an external power supply.

13. The computing system of claim 8, wherein the wired device comprises a Universal Serial Bus (USB) storage device.

14. The computing system of claim 8, wherein the second electrical connection uses a Universal Serial Bus (USB) Type-C connection.

15. A non-transitory computer-readable storage medium, the computer-readable storage medium including instructions that when executed by a computing system, cause the computing system to:
identify a first electrical connection at the detachable case, the first electrical connection including the detachable case receiving power from a wireless charging device, wherein the detachable case provides the received power from the wireless charging device to the mobile device;
identify a second electrical connection at the detachable case, the second electrical connection including the detachable case receiving at least one of power or data from a wired device coupled to the detachable case for transmission to the mobile device; and
when the second electrical connection includes receive power from the wired device, provide the received power from the wired device to the mobile device while refraining from providing the power from the wireless charging device to the mobile device.

16. The non-transitory computer-readable storage medium of claim 15, wherein the detachable case includes at least one coil configured to provide power to the mobile device when the detachable case is electrically coupled to the wireless charging device.

17. The non-transitory computer-readable storage medium of claim 15, wherein the computer-readable storage medium includes further instructions that when executed by a computing system, cause the computing system to:
identify that the at least one of power or data from the wired device includes only data; and
based on identifying, perform the following:
continue to provide the received power from the wireless charging device to the mobile device; and
provide the data received from the wired device to the mobile device.

18. The non-transitory computer-readable storage medium of claim 15, wherein the computer-readable storage medium includes further instructions that when executed by a computing system, cause the computing system to:
identify that the at least one of power or data from the wired device includes power and data; and
based on identifying, perform the following:
provide the received power from the wired device to the mobile device while refraining from providing the power from the wireless charging device; and
provide the data received from the wired device to the mobile device.

19. The non-transitory computer-readable storage medium of claim 15, wherein the wired device comprises an external power supply.

20. The non-transitory computer-readable storage medium of claim 15, wherein the second electrical connection uses a Universal Serial Bus (USB) Type-C connection.
